(19) United States
(12) Patent Application Publication
(10) Pub. No.: US 2009/0251830 A1
(43) Pub. Date: Oct. 8, 2009

(54) MAGNETIC DETECTOR

(75) Inventors: Koji Kurata, Miyagi-ken (JP); Ichiro Tokunaga, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/485,000

(22) Filed: Jun. 15, 2009

Related U.S. Application Data
(63) Continuation of application No. PCT/JP2007/074898, filed on Dec. 26, 2007.

(30) Foreign Application Priority Data
Dec. 28, 2006 (JP) 2006-354740

(51) Int. Cl. G11B 5/33

(52) U.S. Cl. 360/324; G9B/5.104

(57) ABSTRACT

Magnetoresistive elements each have a layered structure including a pinned magnetic layer having a magnetization direction pinned in one direction, a free magnetic layer with magnetization being variable by an external magnetic field, and a nonmagnetic material layer arranged therebetween. Assuming that a center distance between a N-pole and a S-pole of a permanent magnet is λ, the magnetoresistive elements connected in series are arranged in a direction parallel to a relative movement direction with a center distance λ arranged therebetween. Interfaces in the layers of the layered structure of each of the magnetoresistive elements are orthogonal to a facing surface of the permanent magnet, and are in the relative movement direction. The pinned magnetic layers of the magnetoresistive elements have magnetization directions, all the magnetization directions are orthogonal to the relative movement direction in a plane parallel to the interfaces.

### CLAIM OF PRIORITY

This application claims benefit of the Japanese Patent Application No. 2006-354740 filed on Dec. 28, 2006, which is hereby incorporated by reference.

### BACKGROUND OF THE INVENTION

1. Field of the Invention

The present invention relates to a magnetic detector particularly capable of stabilizing an output waveform and increasing detection accuracy as compared with related art.

2. Description of the Related Art

A magnetoresistive element (GMR element) using a giant magnetoresistive effect (GMR effect) can be used for a magnetic encoder.

FIG. 10 is a cross-sectional view partly showing a magnetic encoder of related art. Referring to FIG. 10, a magnet 1 has a surface serving as a magnetized surface. N-poles and S-poles are alternately arranged on the magnetized surface in a relative movement direction of a sensor portion 2.

In FIG. 10, the sensor portion 2 includes a substrate 3 and magnetoresistive elements 4 to 7 formed on a surface of the substrate 3.

The magnetoresistive elements 4 and 6 are connected in series. The magnetoresistive elements 5 and 7 are connected in series. The magnetoresistive elements 4 and 6 define an A-phase half-bridge. The magnetoresistive elements 5 and 7 define a B-phase half-bridge. A center distance (pitch) between the N-pole and the S-pole of the magnet 1 is λ. Referring to FIG. 10, a distance between the centers of the series-connected magnetoresistive elements 4 and 6, and a distance between the centers of the series-connected magnetoresistive elements 5 and 7 are each λ. The magnetoresistive elements 4 to 7 each are formed of a uniform layered body 8. The layered body 8 includes an antiferromagnetic layer 9, a pinned magnetic layer 10, a nonmagnetic material layer 11, and a free magnetic layer 12, stacked on one another in that order from the lower side.

Referring to FIG. 10, magnetization of the pinned magnetic layer 10 is pinned in X1 direction in the drawing by an exchange coupling magnetic field (Hex) generated between the pinned magnetic layer 10 and the antiferromagnetic layer 9. A magnetization direction 10a of the pinned magnetic layer 10 is a direction indicated by an arrow in FIG. 10.

The magnetization direction 10a of the pinned magnetic layer 10 is the same as the relative movement direction of the sensor portion 2.

When the sensor portion 2 relatively moves in the X1 direction in FIG. 10, external magnetic fields H1 and external magnetic fields H2 alternately flow to the magnetoresistive elements 4 to 7 of the sensor portion 2. The external magnetic field H1 is directed from the magnet 1 in a (+) direction toward the relative movement direction. The external magnetic field H2 is directed from the magnet 1 in a (−) direction opposite to the (+) direction.

Regarding the positional relationship between the magnet 1 and the sensor portion 2 shown in FIG. 10, the magnetoresistive element 4 is located directly below the boundary of the N-pole and the S-pole. Hence, an external magnetic field H3 included in the external magnetic field H1 in the (+) direction and arranged in parallel to the X1 direction in the drawing dominantly flows to the magnetoresistive element 4. The magnetoresistive element 5 is located directly below the S-pole. Hence, an external magnetic field H4 in a vertically upward direction (Z1 direction in the drawing) dominantly flows to the magnetoresistive element 5. The magnetoresistive element 6 is located directly below the boundary of the N-pole and the S-pole. Hence, an external magnetic field H5 included in the external magnetic field H2 in the (−) direction and arranged in parallel to the X2 direction in the drawing dominantly flows to the magnetoresistive element 6. The magnetoresistive element 7 is located directly below the N-pole. Hence, an external magnetic field H6 in a vertically downward direction (Z2 direction in the drawing) dominantly flows to the magnetoresistive element 7.

Thusly, a magnetization direction 12a of the free magnetic layer 12 of the magnetoresistive element 4 varies in the same direction as the direction of the external magnetic field H3. Since the magnetization direction 12a of the free magnetic layer 12 and the magnetization direction 10a of the pinned magnetic layer 10 of the magnetoresistive element 4 are the same direction, an electric resistance of the magnetoresistive element 4 is minimized.

A magnetization direction 12a of the free magnetic layer 12 of the magnetoresistive element 6 varies in the same direction as the direction of the external magnetic field H5. Since the magnetization direction 12a of the free magnetic layer 12 and the magnetization direction 10a of the pinned magnetic layer 10 of the magnetoresistive element 6 are opposite directions, an electric resistance of the magnetoresistive element 6 is maximized.

In this way, when the sensor portion 2 moves relative to the magnet 1 in the X1 direction in the drawing, electric resistances of the magnetoresistive elements 4 to 7 are changed as the directions of the external magnetic fields H flowing to the magnetoresistive elements 4 to 7 are changed. A change in voltage in accordance with a change in electric resistance is obtained as a sine-wave output waveform. With the output waveform, for example, a movement speed, a movement distance, etc., of the magnet 1 can be obtained.

However, the magnetic encoder shown in FIG. 10 involves a problem as follows.

Referring to FIG. 10, when the magnetoresistive elements 5 and 7 are respectively located directly below the S-pole and the N-pole, the external magnetic fields H4 and H6 respectively act on the magnetoresistive elements 5 and 7 in a direction orthogonal to a layer interface. At this time, magnetization of the free magnetic layer 12 does not vary. This state is equivalent to a nonmagnetic field state (i.e., state with external magnetic field being zero). In this state, the external magnetic field (sensing magnetic field) H does not act on the magnetoresistive element 5 or 7. In the nonmagnetic field, the magnetization direction of the free magnetic layer 12 is not pinned in one direction. Hence, the electric resistances of the magnetoresistive elements 5 and 7 become unstable. As a result, the output waveform varies and the detection accuracy is decreased.

For example, it is assumed that a disturbance magnetic field H7, other than the external magnetic field (sensing magnetic field) H from the magnet 1, acts on the magnetoresistive elements 4 and 6 shown in FIG. 10 in a direction orthogonal to the magnetization directions 10a of the pinned magnetic layers 10. When the magnetization directions 12a of the free magnetic layers 12 are deflected toward the disturbance magnetic field H7, referring to FIG. 11, the electric resistance of the magnetoresistive element 4 is increased whereas the electric resistance of the magnetoresistive element 6 is decreased. When the disturbance magnetic field H7 acts, the series-connected magnetoresistive elements 4 and 6 exhibit opposite tendencies for increase and decrease in the electric resistances. Accordingly, the output waveform when the disturbance magnetic field H7 acts may greatly vary with respect to a reference output waveform when no disturbance magnetic field H7 acts. The variation in output waveform may result in noise or erroneous operation.

The output waveform may greatly vary even when the disturbance magnetic field H7 acts in a direction other than the direction orthogonal to the magnetization directions 10a of the pinned magnetic layers 10.

Japanese Unexamined Patent Application Publication No. 2000-35343 relates to a rotary magnetic encoder. A positional relationship between a magnetoresistive element and a magnet, and magnetization directions of pinned magnetic layers of magnetoresistive elements are similar to those of the magnetic encoder shown in FIG. 10. The rotary magnetic encoder disclosed in Japanese Unexamined Patent Application Publication No. 2000-35343 may involve a similar problem to that of related art.

### SUMMARY OF THE INVENTION

In light of the situation, the present invention provides a magnetic detector particularly capable of stabilizing an output waveform and increasing detection accuracy.

A magnetic detector according to an aspect of the invention includes a sensor portion on a substrate, the sensor portion having a magnetoresistive element using a magnetoresistive effect, with the effect, an electric resistance being changed by an external magnetic field; and a magnetic field generating member facing the sensor portion with a distance arranged therebetween. The magnetic field generating member has a N-pole and a S-pole alternately magnetized on a facing surface of the magnetic field generating member facing the sensor portion so that an external magnetic field in a (+) direction toward a relative movement direction or a relative rotation direction and an external magnetic field in a (−) direction opposite to the (+) direction alternately act on the magnetoresistive element along with movement or rotation of the sensor portion relative to the magnetic field generating member. A plurality of the magnetoresistive elements are provided on a surface of the substrate, each of the magnetoresistive elements having a layered structure including a pinned magnetic layer having a magnetization direction pinned in one direction, a free magnetic layer with magnetization being variable by the external magnetic field, and a nonmagnetic material layer, the layers being stacked such that the nonmagnetic material layer is arranged between the pinned magnetic layer and the free magnetic layer. When it is assumed that a distance between the centers of the N-pole and S-pole is λ, the magnetoresistive elements connected in series are arranged, with a distance λ arranged between the centers of the magnetoresistive elements, in a direction parallel to the relative movement direction or in a direction parallel to a tangential direction when the center of the surface of the substrate serves as a contact on the relative rotation direction. Interfaces in the layers of the layered structure of each of the magnetoresistive elements are parallel to a plane defined by a minimum distance direction between the sensor portion and the magnetic field generating member, and the relative movement direction or the relative rotation direction. The pinned magnetic layers of the magnetoresistive elements respectively have magnetization directions, all the magnetization directions being orthogonal to the relative movement direction or the relative rotation direction, in a plane parallel to the interfaces. The magnetoresistive elements include first to fourth magnetoresistive elements and form a bridge circuit, the first and second magnetoresistive elements being connected in series with a center distance λ arranged therebetween, the third and fourth magnetoresistive elements being connected in series with a center distance λ arranged therebetween, the first and third magnetoresistive elements being connected in parallel, the second and fourth magnetoresistive elements being connected in parallel. The first and fourth magnetoresistive elements are arranged in a line in a direction orthogonal to the relative movement direction or in a direction orthogonal to the tangential direction, and the second and third magnetoresistive elements are arranged in a line in the direction orthogonal to the relative movement direction or in the direction orthogonal to the tangential direction.

With the aspect, as described above, the interfaces in the layers of the layered structure of each of the magnetoresistive elements are parallel to the plane defined by the minimum distance direction between the sensor portion and the magnetic field generating member, and the relative movement direction or the relative rotation direction. Hence, a rotational magnetic field properly acts within the plane parallel to the interface of the free magnetic layer from the magnetic field member, and unlike related art, the external magnetic field does not act in a direction orthogonal to the interface. Accordingly, a nonmagnetic state (the state with external magnetic field being zero) is not generated for the magnetoresistive element unlike related art, and a variation in output waveform can be decreased as compared with related art.

In addition, with the aspect, as described above, the center distance between the series-connected magnetoresistive elements is controlled. Also, the magnetization directions of the pinned magnetic layers of the magnetoresistive elements are controlled. Accordingly, when a disturbance magnetic field other than the external magnetic field generated from the magnetic field generating member acts on the magnetoresistive elements, tendencies for increase and decrease in electric resistances of the series-connected magnetoresistive elements can be equalized. That is, when the disturbance magnetic field acts, the electric resistances of both the magnetoresistive elements can be increased. As a result, a variation in output waveform with a disturbance magnetic field acting thereon, with respect to the output waveform with no disturbance magnetic field acting, is effectively decreased as compared with related art.

Preferably in the above configuration, the first and third magnetoresistive elements may be connected in parallel via an input terminal, and the second and fourth magnetoresistive elements may be connected in parallel via an earth terminal.

Preferably in the above configuration, a contact between the first and second magnetoresistive elements may serve as a first output extraction portion, and a contact between the third and fourth magnetoresistive elements may serve as a second output extraction portion, the first and second output extraction portions being connected to an input side of a differential amplifier, an output side of the differential amplifier being connected to an output terminal.

Preferably in the above configuration, the magnetoresistive elements may further include fifth to eighth magnetoresistive elements and form a bridge circuit, the fifth and sixth magnetoresistive elements being connected in series with a center distance λarranged therebetween, the seventh and eighth magnetoresistive elements being connected in series with a center distance λ arranged therebetween, the fifth and seventh magnetoresistive elements being connected in parallel, the sixth and eighth magnetoresistive elements being connected in parallel. The fifth and eighth magnetoresistive elements may be arranged in a line in the direction orthogonal to the relative movement direction or in the direction orthogonal to the tangential direction, and the sixth and seventh magnetoresistive elements may be arranged in a line in the direction orthogonal to the relative movement direction or in the direction orthogonal to the tangential direction.

Preferably in the above configuration, A-phase magnetoresistive elements defined by the first to fourth magnetoresistive elements having the bridge circuit structure and B-phase magnetoresistive elements defined by the fifth to eighth magnetoresistive elements having the bridge circuit structure may be formed on a substrate such that the A-phase and B-phase magnetoresistive elements are arranged in the direction parallel to the relative movement direction and shifted from each other by λ/2.

Accordingly, the bridge circuit capable of doubling the output can be properly formed, and the detection accuracy can be increased.

With the magnet detector of the aspect of the invention, the output waveform can be stabilized and the detection accuracy can be increased as compared with related art.

### BRIEF DESCRIPTION OF THE DRAWINGS

FIG. 1 is a perspective view partly showing a magnetic encoder according to an embodiment;

FIG. 2 is an enlarged side view partly showing the magnetic encoder;

FIG. 3 is an enlarged side view partly showing the magnetic encoder;

FIG. 4 is an enlarged cross-sectional view taken along line IV-IV in FIG. 2 in a film-thickness direction and viewed in a direction indicated by arrows;

FIG. 5 is a circuit diagram of a sensor portion;

FIGS. 6A to 6C are explanatory views showing that, when a disturbance magnetic field acts on series-connected magnetoresistive elements of this embodiment, the magnetoresistive elements exhibit equal tendencies for increase and decrease in electric resistances of magnetoresistive elements;

FIGS. 7A to 7C are explanatory views showing a unique positional relationship that, when a disturbance magnetic field acts on series-connected magnetoresistive elements of this embodiment, the magnetoresistive elements exhibit different tendencies for increase and decrease in electric resistances of magnetoresistive elements;

FIG. 8 is a graph showing a reference electric resistance when no disturbance magnetic field acts on the series-connected magnetoresistive elements of this embodiment, and an electric resistance changed when a disturbance magnetic field acts on the magnetoresistive elements;

FIG. 9 is a schematic illustration showing a magnetic encoder according to another embodiment;

FIG. 10 is a cross-sectional view partly showing a magnetic encoder of related art; and

FIG. 11 is a graph showing a reference electric resistance when no disturbance magnetic field acts on series-connected magnetoresistive elements of related art, and an electric resistance changed when a disturbance magnetic field acts on the magnetoresistive elements.

### DESCRIPTION OF THE PREFERRED EMBODIMENTS

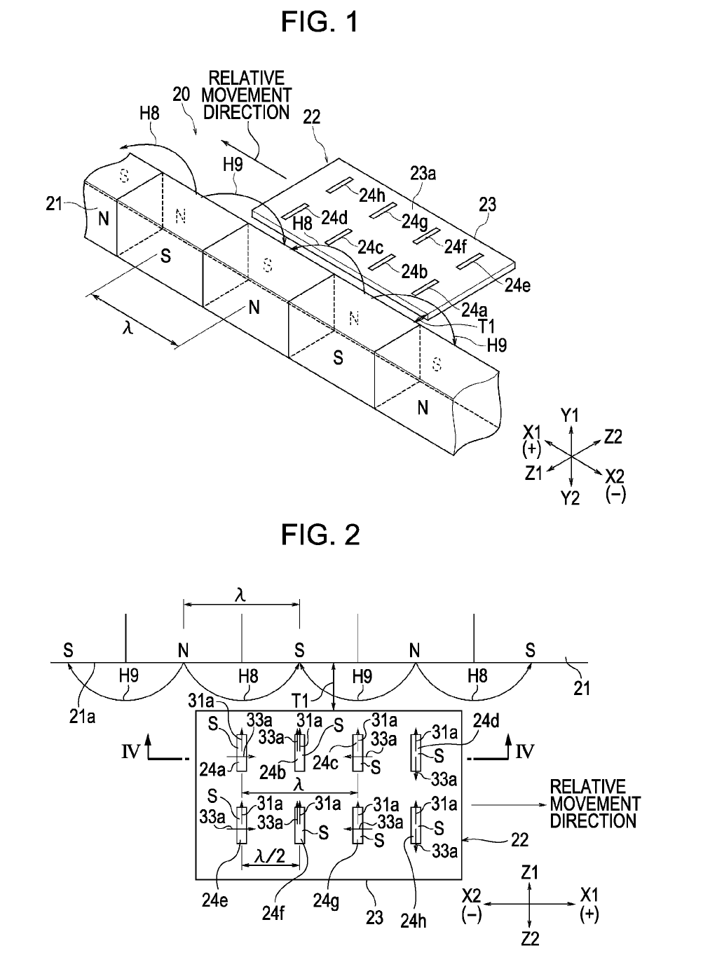

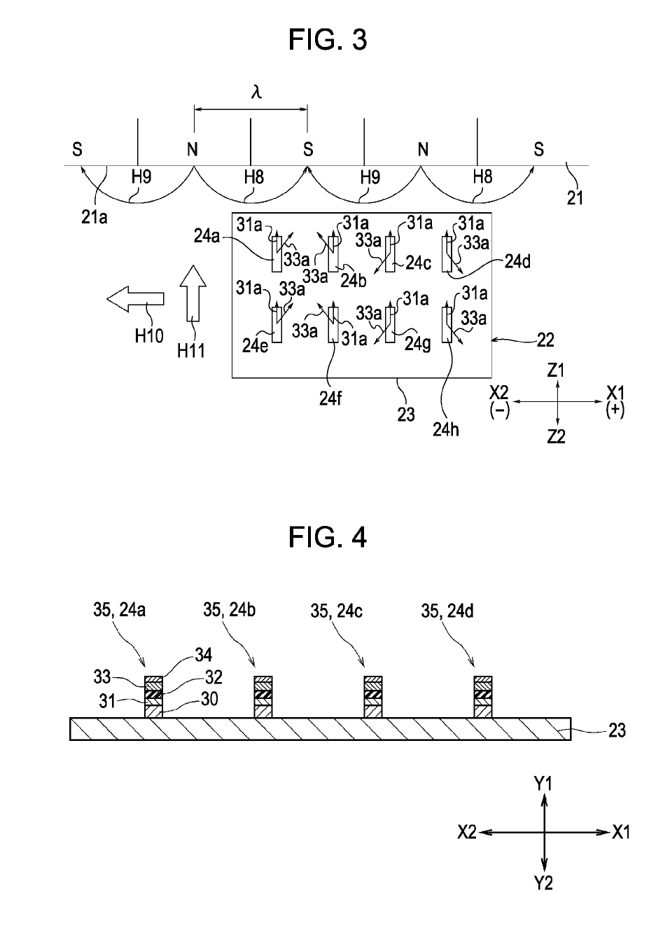

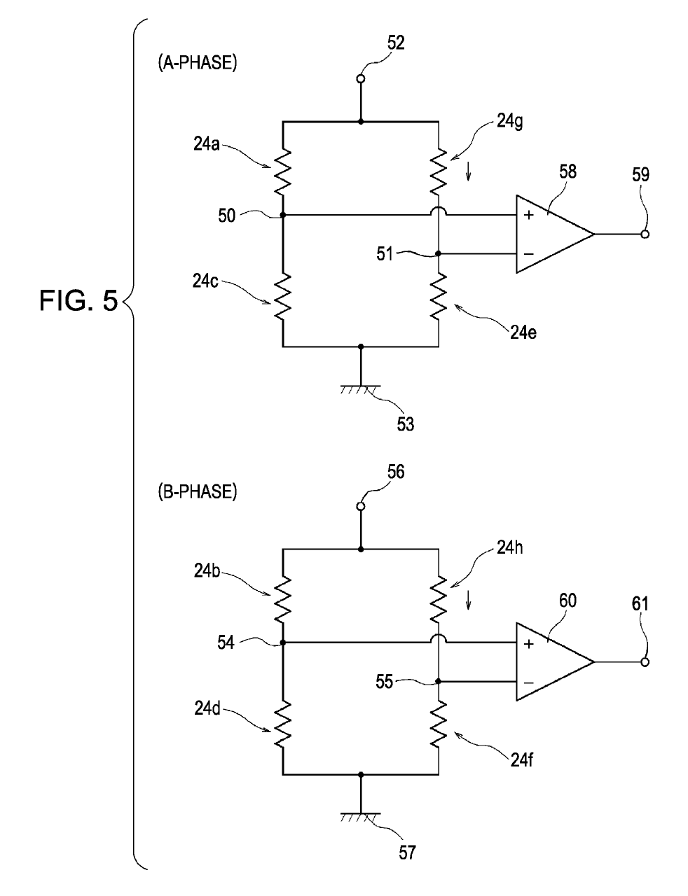

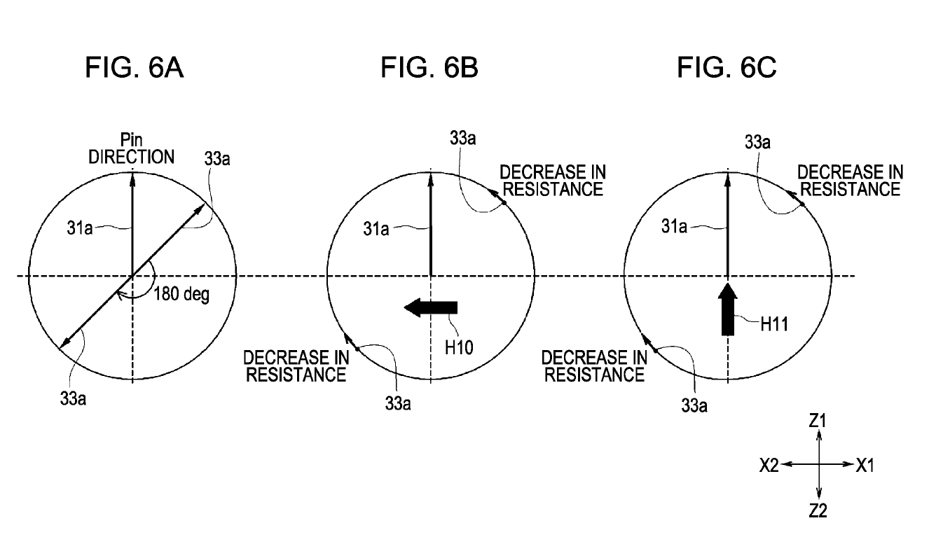

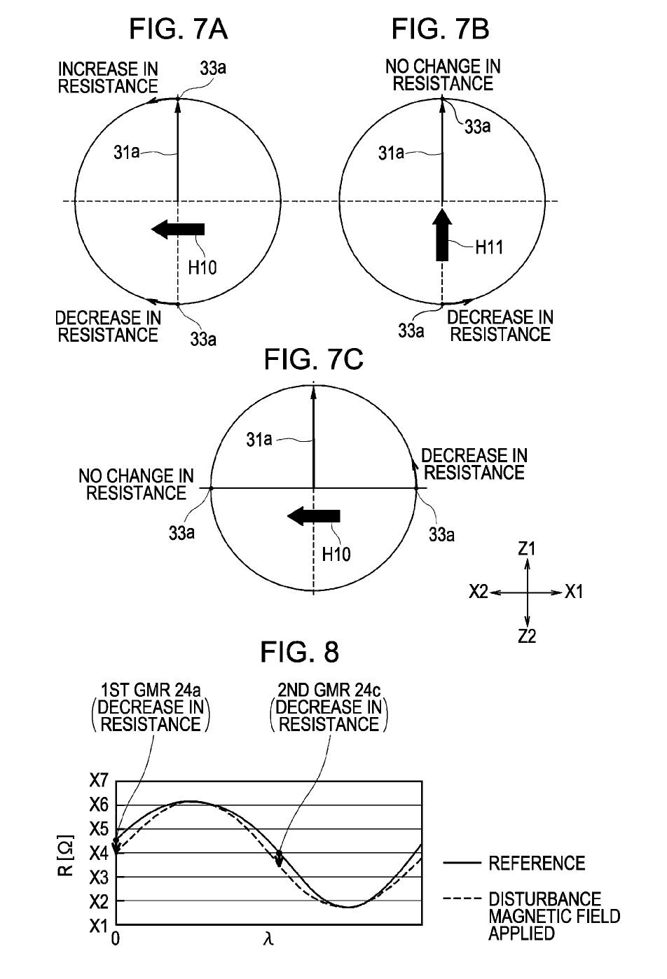

FIG. 1 is a perspective view partly showing a magnetic encoder (magnetic detector) according to this embodiment. FIGS. 2 and 3 are enlarged side views partly showing the magnetic encoder. FIG. 4 is an enlarged cross-sectional view taken along line IV-IV in FIG. 2 in a film-thickness direction and viewed in a direction indicated by arrows. FIG. 5 is a circuit diagram of a sensor portion. FIGS. 6A to 6C are explanatory views showing, when a disturbance magnetic field acts on series-connected magnetoresistive elements of this embodiment, the magnetoresistive elements exhibit equal tendencies for increase and decrease in electric resistances of the magnetoresistive elements. FIGS. 7A to 7C are explanatory views showing a unique positional relationship that, when a disturbance magnetic field acts on the series-connected magnetoresistive elements of this embodiment, the magnetoresistive elements exhibit different tendencies for increase and decrease in electric resistances of the magnetoresistive elements. FIG. 8 is a graph showing a reference electric resistance when no disturbance magnetic field acts on the series-connected magnetoresistive elements of this embodiment, and an electric resistance changed when a disturbance magnetic field acts on the magnetoresistive elements.

In X1-X2 direction, Y1-Y2 direction, and Z1-Z2 direction in the respective drawings, each direction is orthogonal to other two directions. X1 direction is a movement direction of a magnet or a sensor portion. In the Z1-Z2 direction, the magnet and the sensor portion face each other with a predetermined distance arranged therebetween.

Referring to FIG. 1, a magnetic encoder 20 includes a permanent magnet (magnetic field generating member) 21 and a sensor portion 22.

The permanent magnet 21 has a rod-like shape extending in the X1-X2 direction in the drawing. N-poles and S-poles each having a predetermined width are alternately magnetized in the X1-X2 direction in the drawing. A distance (pitch) between the center of a magnetized surface of the N-pole and the center of a magnetized surface of the adjacent S-pole is λ.

Referring to FIG. 1, a predetermined distance (minimum distance) T1 is provided between the permanent magnet 21 and the sensor portion 22.

As shown in FIG. 1, the sensor portion 22 includes a substrate 23, and a plurality of magnetoresistive elements 24a to 24h provided on a surface 23a of the substrate 23.

Referring to FIGS. 1 and 2, the eight magnetoresistive element 24a to 24h are arranged in matrix of four in the X1-X2 direction and two in the Z1-Z2 direction. Referring to FIG. 2, a distance between the centers in a width direction (X1-X2 direction in the drawing) of the magnetoresistive elements adjacent to each other in the X1-X2 direction is λ/2.

Referring to FIG. 4, the magnetoresistive elements 24a to 24h each are formed of the same layered body 35. While FIG. 4 only illustrates the magnetoresistive elements 24a to 24d, the magnetoresistive elements 24e to 24h each are formed of the same layered body. Since all the magnetoresistive elements 24a to 24h are formed of the same layered bodies 35, the magnetoresistive elements 24a to 24h can be formed by the same manufacturing process. Though described later, magnetization directions 31a of all the pinned magnetic layers 31 of the magnetoresistive elements 24a to 24h are pinned in the same direction. Hence, by applying heat processing in a magnetic field one time, the magnetization directions 31a of all the pinned magnetic layers 31 can be pinned in the same direction.

Referring to FIG. 4, each magnetoresistive element is formed of the layered body 35 including an antiferromagnetic layer 30, a pinned magnetic layer 31, a nonmagnetic material layer 32, a free magnetic layer 33, and a protective layer 34, stacked on one another in that order from the lower side. The film structure of the layered body 35 is not limited to one shown in FIG. 4. In the layered body 35, a base layer may be formed between the antiferromagnetic layer 30 and the substrate 23. Also, in the layered body 35, the free magnetic layer 33, the nonmagnetic material layer 32, the pinned magnetic layer 31, the antiferromagnetic layer 30, and the protective layer 34 may be stacked on one another in that order from the lower side.

The antiferromagnetic layer 30 is made of, for example, PtMn or IrMn. The pinned magnetic layer 31 and the free magnetic layer 33 are made of, for example, NiFe or CoFe. The nonmagnetic material layer 32 is made of, for example, Cu. The protective layer 34 is made of, for example, Ta.

Magnetization of the pinned magnetic layer 31 is pinned in one direction by an exchange coupling magnetic field (Hex) generated between the pinned magnetic layer 31 and the antiferromagnetic layer 30 through the heat processing in a magnetic field. Referring to FIGS. 2 and 3, the magnetization directions 31a of the pinned magnetic layers 31 of all the magnetoresistive elements 24a to 24h are pinned in the Z1 direction in the drawing. In contrast, magnetization directions of the free magnetic layers 33 are not pinned and vary by an external magnetic field (sensing magnetic field).

In this embodiment, a tunnel magnetoresistive element (TMR element) including a nonmagnetic material layer 32 made of an insulating material such as Al2O3 may be used instead of the GMR element including the nonmagnetic material layer 32 made of a nonmagnetic conductive material and using a giant magnetoresistive effect (GMR effect).

In the following description, the magnetoresistive element 24a is called a first magnetoresistive element 24a, the magnetoresistive element 24b is called a fifth magnetoresistive element 24b, the magnetoresistive element 24c is called a second magnetoresistive element 24c, the magnetoresistive element 24d is called a sixth magnetoresistive element 24d, the magnetoresistive element 24e is called a fourth magnetoresistive element 24e, the magnetoresistive element 24f is called an eighth magnetoresistive element 24f, the magnetoresistive element 24g is called a third magnetoresistive element 24g, and the magnetoresistive element 24h is called a seventh magnetoresistive element 24h.

Referring to FIG. 5, the first magnetoresistive element 24a, the second magnetoresistive element 24c, the third magnetoresistive element 24g, and the fourth magnetoresistive element 24e define an A-phase bridge circuit. The first magnetoresistive element 24a and the second magnetoresistive element 24c may be connected in series via a first output extraction portion 50. The fourth magnetoresistive element 24e and the third magnetoresistive element 24g may be connected in series via a second output extraction portion 51. As shown in FIG. 5, the first magnetoresistive element 24a and the third magnetoresistive element 24g may be connected in parallel via an input terminal 52. The second magnetoresistive element 24c and the fourth magnetoresistive element 24e may be connected in parallel via an earth terminal 53.

In FIG. 5, the first and second output extraction portions 50 and 51 may be connected to an input side of a first differential amplifier 58, and an output side of the first differential amplifier 58 may be connected to a first output terminal 59.

In this embodiment, the fifth magnetoresistive element 24b, the sixth magnetoresistive element 24d, the seventh magnetoresistive element 24h, and the eighth magnetoresistive element 24f may define a B-phase bridge circuit. The fifth magnetoresistive element 24b and the sixth magnetoresistive element 24d may be connected in series via a third output extraction portion 54. The eighth magnetoresistive element 24f and the seventh magnetoresistive element 24h may be connected in series via a fourth output extraction portion 55. As shown in FIG. 5, the fifth magnetoresistive element 24b and the seventh magnetoresistive element 24h may be connected in parallel via an input terminal 56. The sixth magnetoresistive element 24d and the eighth magnetoresistive element 24f may be connected in parallel via an earth terminal 57.

In FIG. 5, the third and fourth output extraction portions 54 and 55 may be connected to an input side of a second differential amplifier 60, and an output side of the second differential amplifier 60 may be connected to a second output terminal 61.

Referring to FIG. 2, a distance between the centers of the series-connected magnetoresistive elements in the bridge circuit shown in FIG. 5 is λ.

In this embodiment, one of the sensor portion 22 and the permanent magnet 21 is supported linearly movably in a direction parallel to the X1-X2 direction in the drawing. In this embodiment, an external magnetic field region generated by the permanent magnet 21 is formed within a relative movement space of the sensor portion 22. Herein, when it is assumed that the relative movement direction (in FIG. 1, the X1 direction in the drawing) is a (+) direction, and that a direction opposite to the relative movement direction (in FIG. 1, the X2 direction in the drawing) is a (−) direction, referring to FIGS. 1 and 2, an external magnetic field H8 in the (+) direction toward the relative movement direction, and an external magnetic field H9 in the (−) direction opposite to the relative movement direction, are alternately generated in the external magnetic field region.

In this embodiment, referring to FIGS. 1 to 4, the surface (a formation surface with the magnetoresistive elements formed thereon) 23a of the substrate 23 is parallel to a plane defined by a minimum distance direction between the sensor portion 22 and the permanent magnet 21 (i.e., in a distance T1 direction; in the Z1-Z2 direction in the drawing), and the relative movement direction (in the X1 direction in the drawing). That is, the surface 23a of the substrate 23 is arranged in a plane direction parallel to the X-Z plane in the drawing.

Hence, interfaces in the layers of each of the magnetoresistive elements 24a to 24h formed on the surface 23a of the substrate 23 are arranged in the plane direction parallel to the X-Z plane in the drawing. A surface S of each of the magnetoresistive elements 24a to 24h shown in FIG. 2 is a plane parallel to the interface (hereinafter, the plane referred to as interface S).

In FIG. 2, an external magnetic field H in the arrow X1 direction included in the external magnetic field H8 from the permanent magnet 21 dominantly flows to the first magnetoresistive element 24a and the fourth magnetoresistive element 24e. Thus, the magnetization directions 33a of the free magnetic layers 33 of the first magnetoresistive element 24a and the fourth magnetoresistive element 24e are directed in the X1 direction in the drawing.

Also, in FIG. 2, an external magnetic field H in the arrow Z1 direction included in the external magnetic field H from the permanent magnet 21 dominantly flows to the fifth magnetoresistive element 24b and the eighth magnetoresistive element 24f. Thus, the magnetization directions 33a of the free magnetic layers 33 of the fifth magnetoresistive element 24b and the eighth magnetoresistive element 24f are directed in the Z1 direction in the drawing.

Also, in FIG. 2, an external magnetic field H in the arrow X2 direction included in the external magnetic field H9 from the permanent magnet 21 dominantly flows to the second magnetoresistive element 24c and the third magnetoresistive element 24g. Thus, the magnetization directions 33a of the free magnetic layers 33 of the second magnetoresistive element 24c and the third magnetoresistive element 24g are directed in the X2 direction in the drawing.

Also, in FIG. 2, an external magnetic field H in the arrow Z2 direction included in the external magnetic field H from the permanent magnet 21 dominantly flows to the sixth magnetoresistive element 24d and the seventh magnetoresistive element 24h. Thus, the magnetization directions 33a of the free magnetic layers 33 of the sixth magnetoresistive element 24d and the seventh magnetoresistive element 24h are directed in the Z2 direction in the drawing.

In this embodiment, as shown in FIG. 2, the external magnetic field H from the permanent magnet 21 acting on the free magnetic layers 33 of the magnetoresistive elements 24a to 24h acts within a plane parallel to the interfaces S. When the sensor portion 22 relatively moves in the X1 direction in the drawing, the external magnetic field H acts as a rotational magnetic field to the plane parallel to the interfaces S of the free magnetic layers 33 of the magnetoresistive elements 24a to 24h.

Accordingly, in this embodiment, unlike related art, a nonmagnetic field state (the state with external magnetic field H being zero) is not generated, in the nonmagnetic field state, the external magnetic field H not acting on the free magnetic layers 33. In this embodiment, the external magnetic field H always acts on each free magnetic layer 33. The magnetization direction 33a of the free magnetic layer 33 is directed in the direction of the external magnetic field H acting on each of the magnetoresistive elements 24a to 24h. As described above, in this embodiment, a nonmagnetic field condition is not generated, and a variation in reproduced waveform can be decreased as compared with related art.

In this embodiment, as shown in FIG. 2, the series-connected magnetoresistive elements are arranged with a center distance X arranged therebetween. Also, the magnetization directions 31a of the pinned magnetic layers 31 are pinned to each other in the direction orthogonal to the relative movement direction in the plane parallel to the interface S.

When the above-mentioned relationship is achieved, the tendencies for increase and decrease in electric resistances between the series-connected magnetoresistive elements can be equalized even when a disturbance magnetic field H other than the external magnetic field (sensing magnetic field) H from the permanent magnet 21 acts on the magnetoresistive elements 24a to 24h.

Equalization of the tendencies will be described below by using the series-connected first magnetoresistive element 24a and second magnetoresistive element 24c.

It is assumed that the sensor portion 22 linearly moves in the relative movement direction (the X1 direction in the drawing) only by λ/4 from the state shown in FIG. 2. The state is shown in FIG. 3.

The directions of the external magnetic fields H acting on the magnetoresistive elements 24a to 24h are changed. Hence, the magnetization directions 33a of the free magnetic layers 33 of the magnetoresistive elements 24a to 24h vary.

FIG. 6A is an explanatory view schematically showing the magnetization directions 31a of the pinned magnetic layers 31 and the magnetization directions 33a of the free magnetic layers 33 of the first magnetoresistive element 24a and the second magnetoresistive element 24c in the state shown in FIG. 3.

As shown in FIG. 6A, the magnetization directions 33a of the free magnetic layers 33 of the first magnetoresistive element 24a and the second magnetoresistive element 24c are antiparallel to each other (at 180 degrees).

Herein, referring to FIG. 3, it is assumed that a disturbance magnetic field H10 acts in the X2 direction in the drawing, that is, in a direction orthogonal to the magnetization directions 31a of the pinned magnetic layers 31. As shown in FIG. 6B, the magnetization directions 33a of the free magnetic layers 33 of the first magnetoresistive element 24a and the second magnetoresistive element 24c are inclined toward the disturbance magnetic filed H10. Hence, from the state in FIG. 6A to the state in FIG. 6B, in the first magnetoresistive element 24a and the second magnetoresistive element 24c, the magnetization directions 33a of the free magnetic layers 33 approach to the magnetization directions 31a of the pinned magnetic layers 31. Accordingly, the electric resistances of the first magnetoresistive element 24a and the second magnetoresistive element 24c are decreased.

Also, referring to FIG. 3, it is assumed that a disturbance magnetic field H11 acts in the Z1 direction in the drawing, that is, in the same direction as the magnetization directions 31a of the pinned magnetic layers 31. As shown in FIG. 6C, the magnetization directions 33a of the free magnetic layers 33 of the first magnetoresistive element 24a and the second magnetoresistive element 24c are inclined toward the disturbance magnetic filed H11. Hence, from the state in FIG. 6A to the state in FIG. 6C, in the first magnetoresistive element 24a and the second magnetoresistive element 24c, the magnetization directions 33a of the free magnetic layers 33 approach to the magnetization directions 31a of the pinned magnetic layers 31. Accordingly, the electric resistances of the first magnetoresistive element 24a and the second magnetoresistive element 24c are decreased.

When the series-connected first magnetoresistive element 24a and second magnetoresistive element 24c receive the disturbance magnetic field H10 or H11, as also shown in FIG. 8, the electric resistances may be decreased as compared with a reference electric resistance with no disturbance magnetic field H10 or H11 acting.

The directions of the disturbance magnetic fields H10 and H11 shown in FIG. 3 are merely determined for convenience of description, and the directions of the disturbance magnetic field H is not particularly limited. When a disturbance magnetic field acts in a plane direction parallel to the interfaces S, the tendencies for increase and decrease in electric resistances of the series-connected magnetoresistive elements are equalized. In FIGS. 6A to 6C, the electric resistances of the first magnetoresistive element 24a and the second magnetoresistive element 24c are decreased when receiving the disturbance magnetic field H10 or H11. However, the electric resistances may be increased. For example, when a disturbance magnetic field acts in a direction opposite to the direction of the disturbance magnetic field H10, the electric resistances of the first magnetoresistive element 24a and the second magnetoresistive element 24c are increased.

FIGS. 7A to 7C each illustrate a positional relationship between the magnetization directions 31a of the pinned magnetic layers 31 and the magnetization directions 33a of the free magnetic layers 33 of the series-connected magnetoresistive elements, the tendencies for increase and decrease in electric resistances of the series-connected magnetoresistive elements being different from each other when a disturbance magnetic field H other than the external magnetic field (sensing magnetic field) H from the permanent magnet 21 acts on the magnetoresistive elements 24a to 24h.

In FIG. 7A, when the disturbance magnetic field H does not act, the magnetization direction 33a of the free magnetic layer 33 of one of the series-connected magnetoresistive elements is directed in the same direction as the magnetization directions 31a of the pinned magnetic layers 31, and the magnetization direction 33a of the free magnetic layer 33 of the other of the series-connected magnetoresistive elements is directed in a direction opposite to the magnetization directions 31a of the pinned magnetic layers 31. At this time, when the disturbance magnetic field H10 acts in the direction orthogonal to the magnetization directions 31a of the pinned magnetic layers 31, the electric resistance of the one magnetoresistive element is increased whereas the electric resistance of the other magnetoresistive element is decreased. In FIG. 7B, when the disturbance magnetic field H11 acts in the same direction as the magnetization directions 31a of the pinned magnetic layers 31, the electric resistance of the one magnetoresistive element is not changed whereas the electric resistance of the other magnetoresistive element is decreased.

In FIG. 7C, when the disturbance magnetic field H does not act, the magnetization directions 33a of the free magnetic layers 33 of the series-connected magnetoresistive elements are antiparallel to each other, and are orthogonal to the magnetization directions 31a of the pinned magnetic layers 31. At this time, when the disturbance magnetic field H10 acts in the direction orthogonal to the magnetization directions 31a of the pinned magnetic layers 31, the electric resistance of the one magnetoresistive element is not changed whereas the electric resistance of the other magnetoresistive element is decreased.

However, the two modes of the magnetization relationships between the free magnetic layers 33 and the pinned magnetic layers 31 described in FIGS. 7A to 7C each are formed at an instant transfer point coming every λ/2 in the relative movement range of the sensor portion 22. That is, in a major part of the relative movement range of the sensor portion 22, unlike related art, the tendencies for increase and decrease in electric resistances of the series-connected magnetoresistive elements are equalized when the disturbance magnetic field H acts as described with reference to FIGS. 6A to 6C.

Hence, in this embodiment, a variation in output waveform with a disturbance magnetic field H acting, with respect to an output waveform with no disturbance magnetic field H acting, is effectively decreased as compared with related art.

As described above, with this embodiment, the output waveform can be stabilized and the detection accuracy can be increased as compared with related art.

In this embodiment, in the case of the first magnetoresistive element 24a, the second magnetoresistive element 24c, the fourth magnetoresistive element 24e, and the third magnetoresistive element 24g defining the A-phase bridge circuit shown in FIG. 5, the electric resistances are changed when the sensor portion 22 or the permanent magnet 21 moves, and a substantially sine-wave output waveform is obtained from the first output terminal 59.

Also, in the case of the fifth magnetoresistive element 24b, the sixth magnetoresistive element 24d, the eighth magnetoresistive element 24f, and the seventh magnetoresistive element 24h defining the B-phase bridge circuit, the electric resistances are changed when the sensor portion 22 or the permanent magnet 21 moves, and a substantially sine-wave output waveform is obtained from the second output terminal 61.

The phase of the output waveform output from the first output terminal 59 is shifted from the phase of the output waveform output from the second output terminal 61. With the output, the movement speed and the movement distance of the sensor portion 22 or the permanent magnet 21 can be detected. In addition, if the A-phase and B-phase bridge circuits are provided and the two systems of the outputs are provided, the movement direction can be provided by detecting a shift direction of the phase of the output waveform of the second output terminal 61 with respect to the phase of the output waveform of the first output terminal 59.

In this embodiment, referring to FIG. 2, in the A-phase bridge circuit, the series-connected first magnetoresistive element 24a and second magnetoresistive element 24c are arranged with the center distance λ provided therebetween, and the series-connected third magnetoresistive element 24g and fourth magnetoresistive element 24e are arranged with the center distance λ provided therebetween. In addition, the first magnetoresistive element 24a and the fourth magnetoresistive element 24e are arranged in the direction (the Z1-Z2 direction in the drawing) orthogonal to the relative movement direction (the X1 direction in the drawing). Also, the second magnetoresistive element 24c and the third magnetoresistive element 24g are arranged in the direction (the Z1-Z2 direction in the drawing) orthogonal to the relative movement direction (the X1 direction in the drawing). The B-phase and the A-phase may be merely shifted from each other by λ/2. The arrangement of the magnetoresistive elements of the B-phase is similar to that of the A-phase. Accordingly, the bridge circuit capable of doubling the output can be properly formed, and the detection accuracy can be increased.

As described above, the bridge circuit is formed. In this case, if a differential is amplified while a disturbance magnetic field acts on the bridge circuit, a variation in output may be amplified. However, even when the bridge circuit is formed, by using this embodiment, the major part of the relative movement range is in the state described with reference to FIGS. 6A to 6C. In the entire relative movement range, the variation in output occurring when a disturbance magnetic field ranging from about 10 to 20 Oe in maximum acts, is very small. Thus, amplifying a differential and increasing an output width are effective for increasing the detection accuracy.

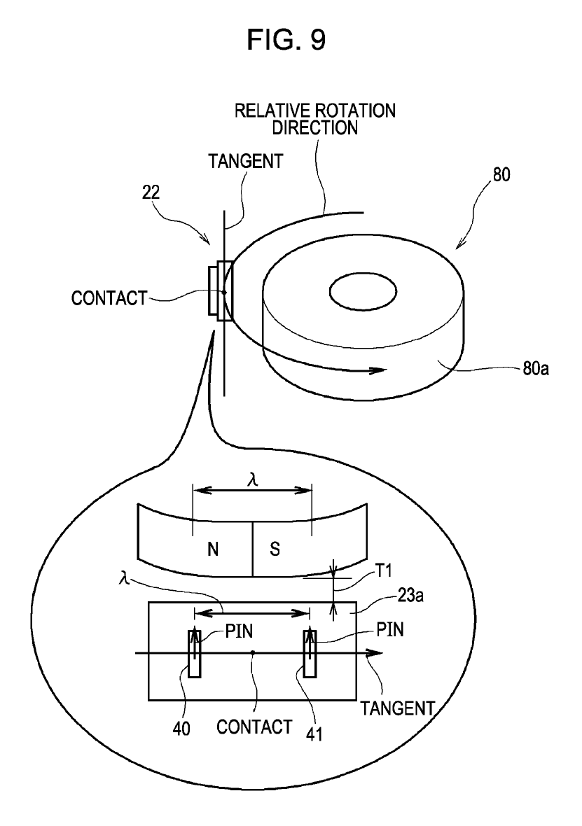

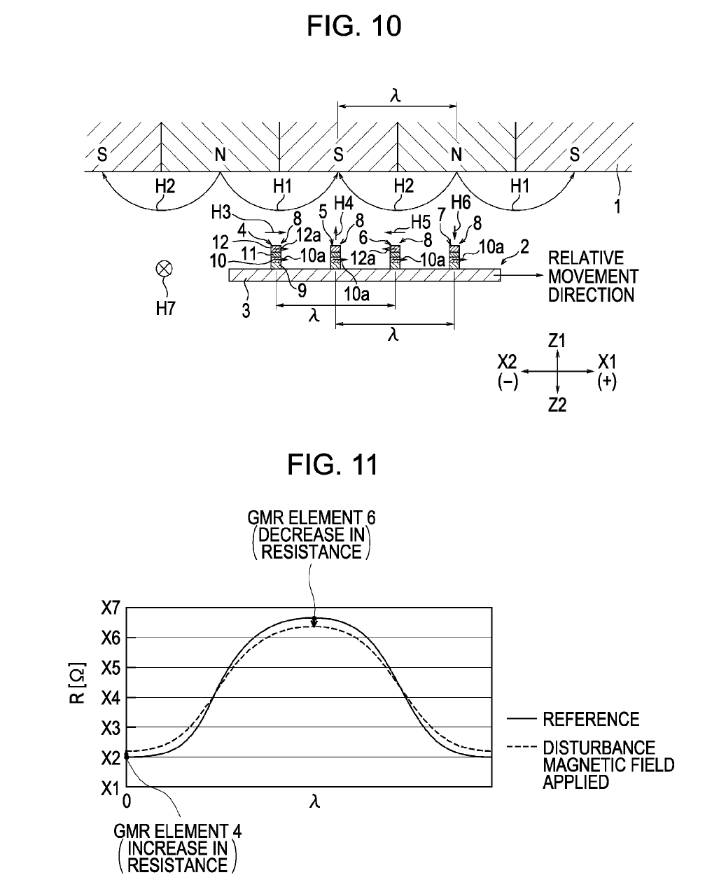

In the magnetic encoder 20 of this embodiment, the sensor portion 22 linearly moves relative to the permanent magnet 21 as shown in FIG. 1. For example, referring to FIG. 9, a rotary magnetic encoder including the sensor portion 22 and a rotating drum 80 having alternately magnetized N-poles and S-poles on a surface 80a of the rotating drum 80 may be employed. The rotary magnetic encoder can detect a rotation speed, the number of rotations, and a rotation direction by using the output obtained by rotation of the rotating drum 80.

Referring to an enlarged view in FIG. 9, assuming that a distance (pitch) between the centers of the N-pole and S-pole is λ in a similar manner to the linearly movable magnetic encoder shown in FIG. 1, a distance between the centers of series-connected magnetoresistive elements 40 and 41 is controlled to be λ. FIG. 9 shows only the two series-connected magnetoresistive elements 40 and 41.

Interfaces in layers of layered structures of each of the magnetoresistive elements 40 and 41 are parallel to a plane defined by a minimum distance direction (the distance T1 direction) between the sensor portion 22 and the rotating drum 80 and a tangential direction determined when the center of the surface 23a of the substrate 23 of the sensor portion 22 serves as a contact on a relative rotation direction of the sensor portion 22.

Referring to FIG. 9, magnetization directions (PIN directions) of pinned magnetic layers 31 of the magnetoresistive elements 40 and 41 are pinned to a direction orthogonal to the tangential direction.

Accordingly, a nonmagnetic state is not generated. Also, when a disturbance magnetic field acts, the tendencies for increase and decrease in electric resistances of the series-connected magnetoresistive elements can be equalized. Thus, the reproduced waveform can be stabilized and the detection accuracy can be increased.

While the A-phase and B-phase bridge circuits are provided in this embodiment as shown in FIGS. 7A to 7C, one of the bridge circuits may be provided.

What is claimed is:

1. A magnetic detector comprising:
a sensor portion on a substrate, the sensor portion having a magnetoresistive element using a magnetoresistive effect, with the effect, an electric resistance being changed by an external magnetic field; and
a magnetic field generating member facing the sensor portion with a distance arranged therebetween,
wherein the magnetic field generating member has a N-pole and a S-pole alternately magnetized on a facing surface of the magnetic field generating member facing the sensor portion so that an external magnetic field in a (+) direction toward a relative movement direction or a relative rotation direction and an external magnetic field in a (−) direction opposite to the (+) direction alternately act on the magnetoresistive element along with movement or rotation of the sensor portion relative to the magnetic field generating member,
wherein a plurality of the magnetoresistive elements are provided on a surface of the substrate, each of the magnetoresistive elements having a layered structure including a pinned magnetic layer having a magnetization direction pinned in one direction, a free magnetic layer with magnetization being variable by the external magnetic field, and a nonmagnetic material layer, the layers being stacked such that the nonmagnetic material layer is arranged between the pinned magnetic layer and the free magnetic layer,
wherein when it is assumed that a distance between the centers of the N-pole and S-pole is λ, the magnetoresistive elements connected in series are arranged, with a distance λ arranged between the centers of the magnetoresistive elements, in a direction parallel to the relative movement direction or in a direction parallel to a tangential direction when the center of the surface of the substrate serves as a contact on the relative rotation direction,
wherein interfaces in the layers of the layered structure of each of the magnetoresistive elements are parallel to a plane defined by a minimum distance direction between the sensor portion and the magnetic field generating member, and the relative movement direction or the relative rotation direction,
wherein the pinned magnetic layers of the magnetoresistive elements respectively have magnetization directions, all the magnetization directions being orthogonal to the relative movement direction or the relative rotation direction, in a plane parallel to the interfaces,
wherein the magnetoresistive elements include first to fourth magnetoresistive elements and form a bridge circuit, the first and second magnetoresistive elements being connected in series with a center distance λ arranged therebetween, the third and fourth magnetoresistive elements being connected in series with a center distance λ arranged therebetween, the first and third magnetoresistive elements being connected in parallel, the second and fourth magnetoresistive elements being connected in parallel, and
wherein the first and fourth magnetoresistive elements are arranged in a line in a direction orthogonal to the relative movement direction or in a direction orthogonal to the tangential direction, and the second and third magnetoresistive elements are arranged in a line in the direction orthogonal to the relative movement direction or in the direction orthogonal to the tangential direction.

2. The magnetic detector according to claim 1, wherein the first and third magnetoresistive elements are connected in parallel via an input terminal, and the second and fourth magnetoresistive elements are connected in parallel via an earth terminal.

3. The magnetic detector according to claim 2, wherein a contact between the first and second magnetoresistive elements serves as a first output extraction portion, and a contact between the third and fourth magnetoresistive elements serves as a second output extraction portion, the first and second output extraction portions being connected to an input side of a differential amplifier, an output side of the differential amplifier being connected to an output terminal.

4. The magnetic detector according to claim 1,
wherein the magnetoresistive elements further include fifth to eighth magnetoresistive elements and form a bridge circuit, the fifth and sixth magnetoresistive elements being connected in series with a center distance λ arranged therebetween, the seventh and eighth magnetoresistive elements being connected in series with a center distance λ arranged therebetween, the fifth and seventh magnetoresistive elements being connected in parallel, the sixth and eighth magnetoresistive elements being connected in parallel, and
wherein the fifth and eighth magnetoresistive elements are arranged in a line in the direction orthogonal to the relative movement direction or in the direction orthogonal to the tangential direction, and the sixth and seventh magnetoresistive elements are arranged in a line in the direction orthogonal to the relative movement direction or in the direction orthogonal to the tangential direction.

5. The magnetic detector according to claim 4, wherein A-phase magnetoresistive elements defined by the first to fourth magnetoresistive elements having the bridge circuit structure and B-phase magnetoresistive elements defined by the fifth to eighth magnetoresistive elements having the bridge circuit structure are formed on a substrate such that the A-phase and B-phase magnetoresistive elements are arranged in the direction parallel to the relative movement direction and shifted from each other by λ/2.
